(19) United States
(12) Patent Application Publication
(10) Pub. No.: US 2022/0116491 A1
(43) Pub. Date: Apr. 14, 2022

(54) MAGNETIC GRIP ACCESSORY

(71) Applicant: PopSockets LLC., Boulder, CO (US)

(72) Inventors: Randy Yang Chiang, San Francisco, CA (US); Lawrence Herman Fong, San Francisco, CA (US); Michael Kory, San Francisco, CA (US); David Czarmecki, San Francisco, CA (US); Nicholas Von Bargen, San Francisco, CA (US); Yinju Chen, San Francisco, CA (US)

(21) Appl. No.: 17/500,789

(22) Filed: Oct. 13, 2021

Related U.S. Application Data
(60) Provisional application No. 63/091,300, filed on Oct. 13, 2020.
(60) Provisional application No. 63/091,297, filed on Oct. 13, 2020.
(60) Provisional application No. 63/091,302, filed on Oct. 13, 2020.
(60) Provisional application No. 63/091,908, filed on Oct. 14, 2020.

(51) Int. Cl. H04M 1/04; F16M 11/38; F16M 11/04; F16M 13/04

(52) U.S. Cl. CPC H04M 1/04; F16M 13/04; F16M 11/041; F16M 11/38

(57) ABSTRACT

An accessory assembly includes a platform with a first side and an opposing second side. The platform includes one or more magnetic elements configured to magnetically attach the platform to a mobile electronic device along the first side. The accessory assembly also includes a grip accessory configured to attached to the second side of the platform, where the grip accessory is configured to be handheld to support the mobile electronic device when magnetically attached to the platform.

### CROSS-REFERENCE TO RELATED APPLICATIONS

This application claims the benefit of U.S. Provisional Application No. 63/091,300, filed on Oct. 13, 2020; U.S. Provisional Application No. 63/091,297, filed on Oct. 13, 2020; U.S. Provisional Application No. 63/091,302, filed on Oct. 13, 2020 and U.S. Provisional Application No. 63/091,908, filed on Oct. 14, 2020, the entire disclosures of which are hereby incorporated by reference.

### FIELD OF THE DISCLOSURE

The present disclosure generally relates to an accessory assembly, and more particularly to a grip accessory and magnetic platform configured to be magnetically attached to a mobile electronic device.

### BACKGROUND

Mobile electronic devices have recently been increasing in size, making it increasingly difficult for users to hold and operate the devices with a single hand. Many use cases and applications benefit from one-handed use. While some accessories are known that may facilitate one-handed use of mobile electronic devices, such accessories are adhesively attached to the mobile electronic device. Therefore, there is a need for a grip accessory that facilitates one-handed use that does not need to be adhesively attached to a mobile electronic device.

### SUMMARY

The disclosure relates to an accessory assembly including a platform with a first side and an opposing second side. The platform includes one or more magnetic elements configured to magnetically attach the platform to a mobile electronic device along the first side. The accessory assembly also includes a grip accessory configured to attached to the second side of the platform, where the grip accessory is configured to be handheld to support the mobile electronic device when magnetically attached to the platform.

### BRIEF DESCRIPTION OF THE DRAWINGS

FIG. 1 is an isometric view of one example of a grip accessory for a mobile electronic device, in an expanded position;

FIG. 2 is an isometric view of a grip accessory of FIG. 1, in a collapsed position;

FIGS. 3A-3B depict cross sectional views of a platform of the grip accessory of FIGS. 1-2, configured to magnetically attach to a mobile device;

FIG. 4 depicts a cross sectional view of an accessory and platform arrangement, configured in accordance with the principles of the invention;

FIG. 5 depicts a cross sectional view of another example of an accessory and platform arrangement configured in accordance with the principles of the invention.

FIG. 6 depicts an exploded view of an accessory and platform arrangement configured in accordance with the principles of the invention;

FIGS. 7A-7C depict various view of the accessory and platform arrangement of FIG. 6;

FIG. 8 depicts another embodiment of an accessory and platform arrangement, configured in accordance with the principles of the invention'

FIGS. 9-10 depict an accessory of the present disclosure configured as a grip accessory removably couplable to a mobile electronic device, in accordance with the principles of the disclosure;

FIGS. 11-13 depict various views of another accessory of the present disclosure configured as a grip accessory and detachable platform, which are removably couplable to a mobile electronic device, in accordance with the principles of the disclosure; and

FIGS. 14-19 depict various views of an accessory attachment system configured as a mobile electronic device case, in accordance with the principles of the disclosure.

### DETAILED DESCRIPTION OF THE EXEMPLARY EMBODIMENTS

The present disclosure generally relates to an accessory assembly, and more particularly to a grip accessory and magnetic platform configured to be magnetically attached to a mobile electronic device.

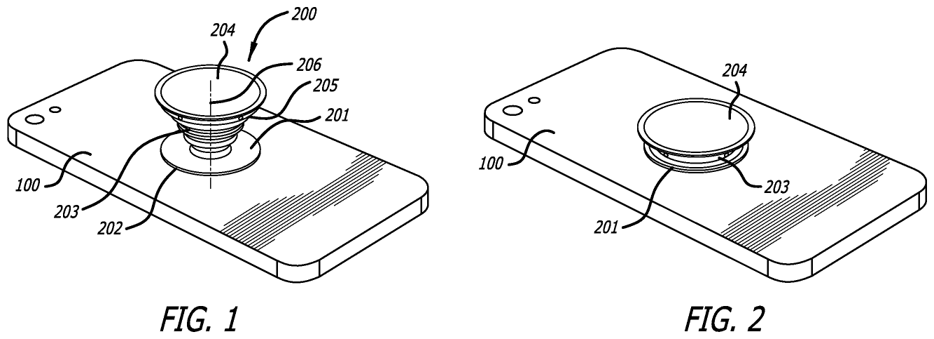

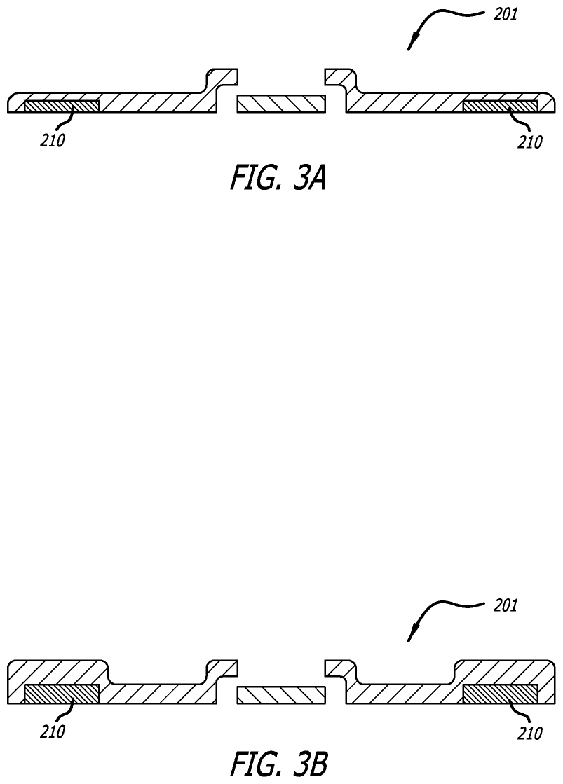

Referring now to FIGS. 1 and 2, depicted is one example of a grip accessory 200 removably coupled to a mobile electronic device 100, which in this example takes the form of a smartphone. In FIGS. 1 and 2, the mobile electronic device 100 has a rear surface that is flat, but this rear surface can instead be curved. The grip accessory 200 is attached to the rear surface of the mobile electronic device 100, as more particularly described below with reference to FIGS. 3A-3B.

As shown in FIGS. 1 and 2, the grip accessory 200 has a platform 201, an accordion 203, and a button 204. The platform 201 can also be referred to as a securing element or a socket board and is generally configured to attach the grip accessory 200 to the mobile electronic device 100 (but can, in other instances, attach the grip accessory 200 to a case for the mobile electronic device 100). The platform 201 can incorporate, for example, one or more magnets 202, for removably attaching the grip accessory 200 to the mobile electronic device 100. The platform 201 can be made from any suitable material such as a thermoplastic polymer, polycarbonate, or the like. Alternatively, any other material, or combination of materials, that provide rigidity to platform 201, can be used.

The accordion 203 is attached to platform 201. The accordion 203 is movable relative to the platform 201 along a central axis 206 of the accessory 200. More specifically, the accordion 203 can expand as shown in FIG. 1 and collapse as shown in FIG. 2. The material used to create and form accordion 203 can be any suitable material such as a flexible thermoplastic elastomer, rubber, or other flexible or semi-rigid material. Accordion 203 can have portions of its walls having different thicknesses, to provide rigidity when expanded, as shown in FIG. 1, and provide flexibility to collapse onto itself, as shown in FIG. 2. In the depicted embodiment, the accordion 203 includes a plurality of folds and has tapered profile converging from a maximum diameter adjacent to the button 204 to a minimum diameter adjacent to the platform 201. The folds can assist with collapsing and expanding the accordion 203 and providing structural integrity when residing in the collapsed state (FIG. 2) and/or expanded state (FIG. 1). The tapered configuration can assist with providing a comfortable ergonomic gripping feature for users. In the disclosed embodiment, the accordion 203 is self-supporting such that no additional structure is required to support the accordion 203 in the expanded position shown in FIG. 1. The grip accessory 200 can further include a biasing member disposed inside of the accordion 203 to bias the accessory 200 into the expanded state depicted in FIG. 1. It should also be appreciated that in embodiments where the accordion 203 includes a biasing mechanism, it may also be beneficial to include a locking feature to retain the accessory 200 in the collapsed configuration against the urging of the biasing device. Such a locking feature may take the form of a snap fit connection between the button 204 of the accessory 200 and the platform 201. It should also be appreciated that in embodiments with biasing devices, the accordion 203 may not necessarily require any folds so that the accordion 203 in fact does not resemble an accordion, but rather, a simple skirt or skin. One example of such a biased accessory is described in U.S. Provisional Patent Application Ser. No. 62/376,237, filed Aug. 17, 2016, the entire contents of which are hereby incorporated herein by reference.

In other embodiments, however, grip accessory 200 may be implemented using structures other than the accordion-based shown in FIGS. 1-2. For example, grip accessory may be implemented using a ring that is hingeably attached to platform 201 such that a user is able to engage the accessory by inserting one or more fingers into an inner opening forming the ring. Other examples of structures which may be used to form grip accessory 200 include kickstands, elastic straps, wallets, wireless or wired power banks, and portable or stationary wireless charging pads. In each case, it should be appreciated that the grip accessory is structured to provide a means by which a user can grasp, hold and support a mobile electronic device using a single hand.

Still referring to FIGS. 1 and 2, a button 204 may be attached to the accordion 203 such that the button 204 is also movable relative to the platform 201 along the axis 206. The button 204 can be co-molded, adhered to, or integrally molded to the accordion 203 such that the button 204 is permanently attached to accordion 203. Alternatively, the button 204 can be removably attached to the accordion 203. For example, the button 204 can be attached to the accordion 203 with tabs 205 extending from button 204 that engage with openings in the accordion 203. The material used to create button 204 can be any suitable material such as polycarbonate. Alternatively, any other material, or combination of materials, can be used to form button 204, such as wood, metal, glass, or the like. Button 204 can also be formed of a rigid material and can have a cavity to hold a different material, such as leather, fabric, gel, or the like. Button 204 can include graphics, printed or molded images, or textures, or combinations thereof, on its surface.

Referring now to FIGS. 3A-3B, depicted is platform 201 configured with one or more magnet elements 210 integrated therein. It should be appreciated that magnetic elements may comprise one or more magnets or alternatively may be formed by metallic elements that are magnetically attracted. In other embodiments, it should be appreciated that the one or more magnetic elements 210 may be integrated into an end of accordion 203, whereby platform 202 may be eliminated and/or otherwise integrated with an end of accordion 203. FIG. 3B depicts a low profile version of the platform design of FIG. 3A.

Moreover, as FIGS. 3A-3B are intended as cross sectional views of platform 203, it should be appreciated that the one or more magnetic elements 210 may comprise a single circular magnet disposed along or near a perimeter of the platform 201, as shown. However, magnetic element(s) 210 may also comprise individual magnets disposed along a periphery of a circular pattern. It should be appreciated that magnetic element(s) 210 may vary in shape, number and position, as noted above, and be arranged on or in a variety of grip accessory shapes. For example, magnetic element(s) 210 may comprise a disc magnet placed at the center of the platform 201 so as to give the magnetic field radial symmetry, such as when controller is otherwise configured to spin about an axis.

Regardless of configuration, magnetic element(s) 210 may be configured to magnetically attract to one or more magnets in mobile electronic device 100 (not shown), thereby causing the platform 201 (and hence the grip accessory 200) to detachably attach to the mobile device 100 when magnetic element(s) 210 are brought into sufficiently close proximity with the mobile device 100. The one or more magnets in the mobile electronic device 100 may be integrally formed with the mobile electronic device 100, such as along or just a housing of the mobile electronic device 100.

In still other embodiments, magnetic element(s) 210 can be replaced or supplemented with a metallic plate-like structure, such as a disc, (e.g., steel disc) that is similar configured to cause the platform 201 (and hence the grip accessory 200) to detachably attach to the mobile device 100 when are brought into sufficiently close proximity with a mobile device 100 which itself incorporates one or more magnets.

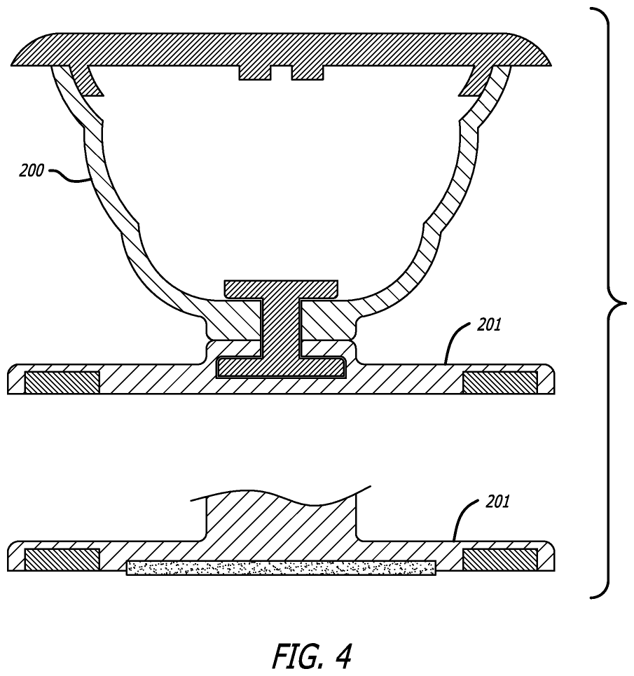

FIG. 4 depicts another example in which the grip accessory 200 is swappable from the platform 201, such as by rotating the grip accessory 200 relative to the platform 201 in an engaging and disengaging manner. One example of such a swappable grip accessory is described in U.S. Pat. No. 10,348,352, filed on May 30, 2018, the entire disclosure of which is hereby incorporated by reference. Moreover, the bottom of the platform 201 may also comprise an optional adhesive for attachment to surfaces/devices that may not include integrated magnets.

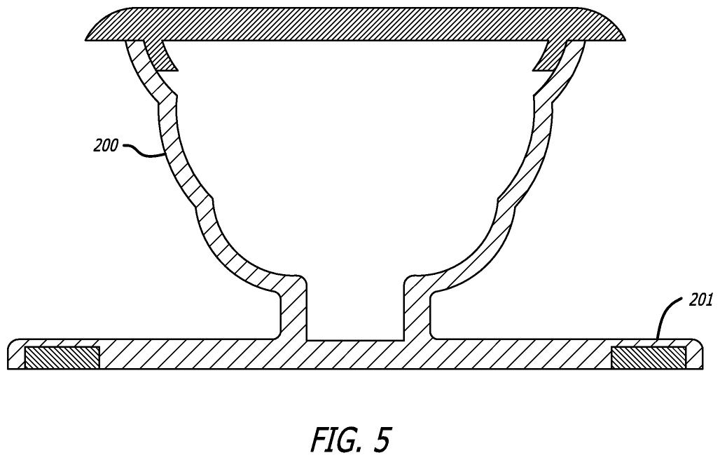

FIG. 5 depicts a non-swappable example in which the grip accessory 200 and platform 201 are integrally formed.

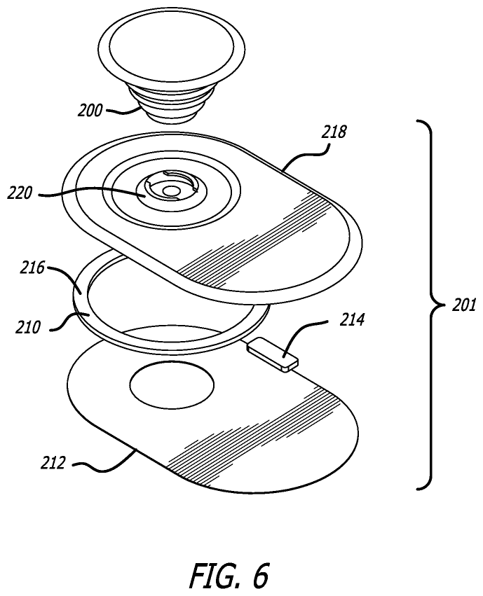

Referring now to FIG. 6, depicted is an exploded view of an accessory and platform arrangement configured in accordance with the principles of the invention. In this example, grip accessory 200 is substantially similar to the accessory described above, including being swappable from the platform, such as by incorporating the design of FIG. 4 above. As shown, in this example platform 201 is substantially oval in shape instead of circular, as previously depicted. It should be appreciated that platform 201 may be configured in other shapes as well.

Platform 201 comprises a base 212, which may be formed by a laminate. Platform 201 further comprises the above-described magnetic element(s) 210, which in the example of FIG. 6 is implemented using a ring-shaped magnet (which may be alternatively formed by a ring-shaped metallic material). Moreover, in the example of FIG. 6, the platform is further configured with an alignment magnet 214, which may be usable to align the platform 201 to a corresponding magnet integrally formed with a mobile electronic device 100 when the platform 201 is otherwise attached to such a device. Magnetic element(s) 210 may also have an adhesive 216 disposed on a top and/or bottom surface so as to further secure the components of the platform 201 in place.

Continuing to refer to FIG. 6, platform 201 further comprises top 218 which is secured to the base 212, with magnetic element(s) 210 and 214 disposed there between, when the platform 201 is fully constructed. Top 218 and base 212 may be adhesively secured together. Top 218 includes securing element 220, which is configured to receive a detachable accessory, such as accessory 200. In certain embodiments, securing element 218 may be an attachment mechanism configured in accordance with the disclosure of previously-incorporated U.S. Pat. No. 10,348,352. However, other attachment mechanisms may similarly be used, including an annular snap, T-channel, hook and loop, etc.

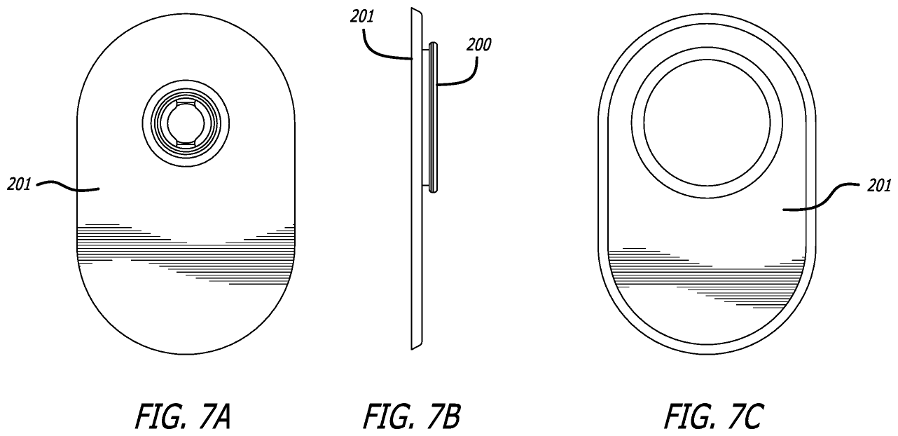

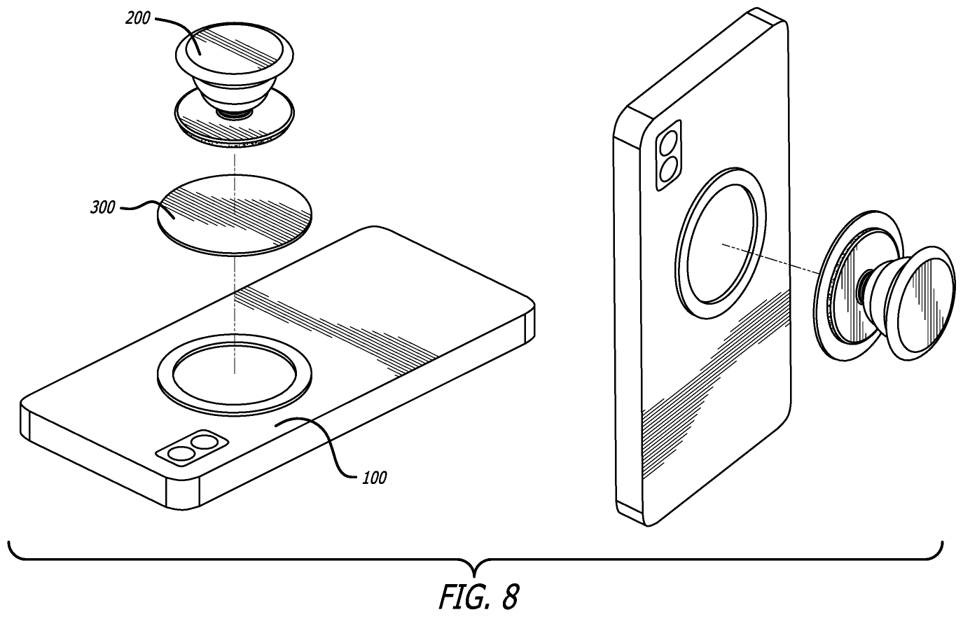

FIGS. 7A-7C depict various views of the accessory and platform arrangement of FIG. 6. FIG. 7A depicts a top view of platform 201 without grip accessory 200 attached. FIG. 7B depicts a side view of platform 201 with grip accessory 200 attached and in a collapsed orientation. Finally, FIG. 7C depicts a bottom view of platform 201, i.e., the attachment surface.

FIG. 8 depicts another embodiment in which the accessory and platform arrangement is implemented by a platform 300 in the form of a metallic disc (e.g., steel) that may be adhesively connected to a grip accessory (e.g., grip accessory 200). The combined structure of the platform 300 and accessory 200 may then be configured to magnetically attach to an electronic mobile device 100. In this fashion, the platform and grip accessory would be collectively attachable and detachable to the device 100 by way of magnetic attraction, such as in the case where the mobile device 100 (or a case in which the mobile device is contained) incorporates one or more magnets, as described above.

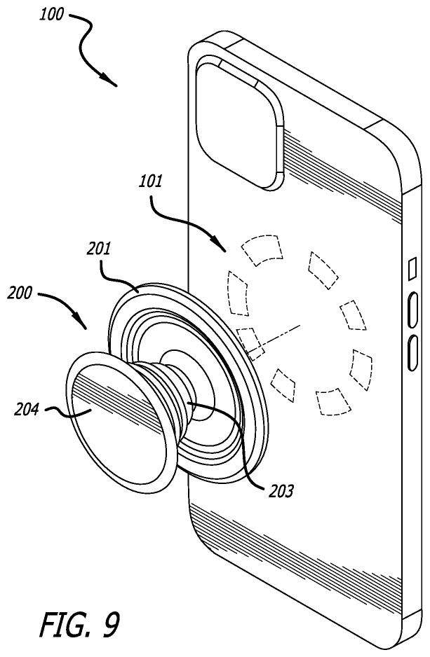

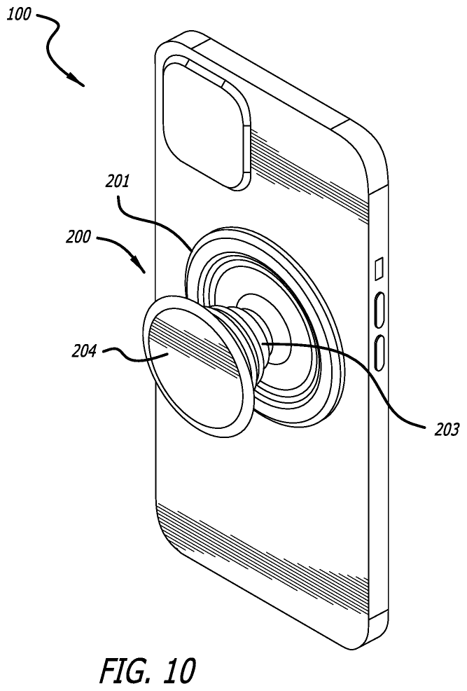

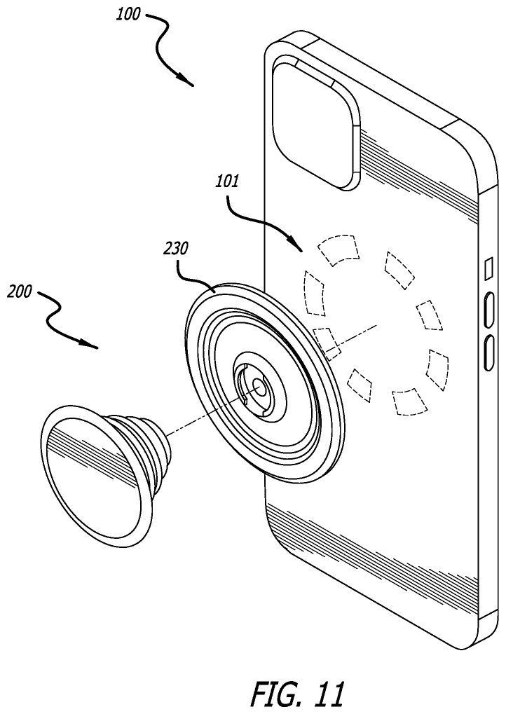

FIGS. 9-10 show another example of an accessory of the present disclosure configured as a grip accessory 200 removably coupled to mobile electronic device 100 (but can, in other instances, attach grip accessory 200 to a case for mobile electronic device 100). While in this example, the accessory 200 is depicted as an expandable grip, it is within the scope of this disclosure that the accessory 200 include other accessory types, such as wallets, wireless or wired power banks, speakers, ear buds, and portable or stationary wireless charging pads, among other accessories.

In FIGS. 9-10, the mobile electronic device 100 has a rear surface that is flat, but this rear surface can instead be curved. The grip accessory 200 is attached to the rear surface of the mobile electronic device 100, as more particularly described below.

As shown in FIGS. 9-10, the grip accessory 200 has a platform 201, an accordion 203, and a button 204. The platform 201 can also be referred to as a securing element or a socket board and is generally configured to attach the grip accessory 200 to the mobile electronic device 100 (but can, in other instances, attach the grip accessory 200 to a case for the mobile electronic device 100). The platform 201 can be made from any suitable material such as a thermoplastic polymer, polycarbonate, or the like. Alternatively, any other material, or combination of materials, that provide rigidity to platform 201, can be used.

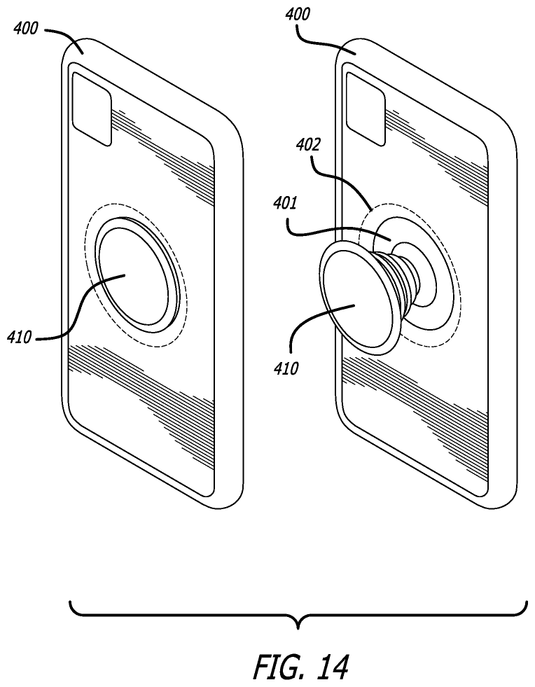

It should be appreciated that the accordion 203 may be movable relative to the platform 201 along a central axis of the accessory 200. More specifically, the accordion 203 can expand as shown in FIGS. 9-10, or can be collapsed into a collapsed state (not shown). An example of the expanded and collapsed states is shown in FIG. 1-2 above and FIG. 14 below.

The material used to create and form accordion 203 can be any suitable material such as a flexible thermoplastic elastomer, rubber, or other flexible or semi-rigid material. Accordion 203 can have portions of its walls having different thicknesses, to provide rigidity when expanded, and provide flexibility to collapse onto itself, as shown in FIG. 2. In the depicted embodiment, the accordion 203 includes a plurality of folds and has tapered profile converging from a maximum diameter adjacent to the button 204 to a minimum diameter adjacent to the platform 201. The folds can assist with collapsing and expanding the accordion 203 and providing structural integrity when residing in the collapsed state and/or expanded state. The tapered configuration can assist with providing a comfortable ergonomic gripping feature for users. In the disclosed embodiment, the accordion 203 is self-supporting such that no additional structure is required to support the accordion 203 in the expanded position shown in FIG. 1. In other embodiments, however, other structures can be used. In fact, in one embodiment, the socket accessory 200 can further include a biasing member disposed inside of the accordion 203 to bias the accessory 200 into the expanded state depicted in FIGS. 9-10. It should also be appreciated that, in embodiments where the accordion 203 includes a biasing mechanism, it may also be beneficial to include a locking feature to retain the accessory 200 in the collapsed configuration against the urging of the biasing device. Such a locking feature may take the form of a snap fit connection between the button 204 of the accessory 200 and the platform 201. It should also be appreciated that in embodiments with biasing devices, the accordion 203 may not necessarily require any folds so that the accordion 203 in fact does not resemble an accordion, but rather, a simple skirt or skin. One example of such a biased accessory is described in U.S. Provisional Patent Application Ser. No. 62/376,237, filed Aug. 17, 2016, the entire contents of which are hereby incorporated herein by reference.

Still referring to FIGS. 9-10, the button 204 is attached to the accordion 203 such that the button 204 is also movable relative to the platform 201. The button 204 can be co-molded, adhered to, or integrally molded to the accordion 203 such that the button 204 is permanently attached to accordion 203. Alternatively, the button 204 can be removably attached to the accordion 203. For example, the button 204 can be attached to the accordion 203 with tabs extending from the button 204 that engage with openings in the accordion 203. The material used to create button 204 can be any suitable material such as polycarbonate. Alternatively, any other material, or combination of materials, can be used to form button 204, such as wood, metal, glass, or the like. Button 204 can also be formed of a rigid material and can have a cavity to hold a different material, such as leather, fabric, gel, or the like. Button 204 can include graphics, printed or molded images, or textures, or combinations thereof, on its surface.

Grip accessory 200 may be attachable to the rear surface of mobile electronic device 100 by magnetic, adhesive, or mechanical means and is constructed to be detachable. Mobile electronic device 100 (or case) and grip accessory 200 may include protrusions, recesses, and locking mechanisms to limit risk of unintended release of grip accessory 200 from mobile electronic device 100.

Moreover, in the embodiment of FIG. 9, mobile electronic device 100 comprises a plurality magnets or magnetic attracting material 101 (collectively referred to herein as “magnets”) integrated thereon and/or therein. In certain embodiments, grip accessory 200 may comprise metallic and/or magnetic elements (not shown) which are attracted to the plurality of magnets 101 when the grip accessory 200 and device 100 are brought within a sufficiently close proximity to each other. It should be appreciated that the plurality of magnets 101 may comprise a single ring-shaped magnet, a single disc-shaped magnet, one or more additional magnets disclosed nearer the base or edge of the phone, or any combination thereof. Similarly, the metallic and/or magnetic elements of the grip accessory 200 may have a ring or disc shape, or comprise individual magnets (or metal) disposed in any pattern along the attachment side of platform 201.

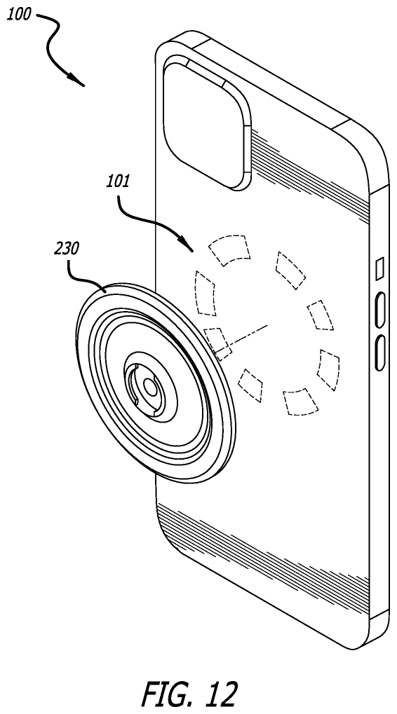

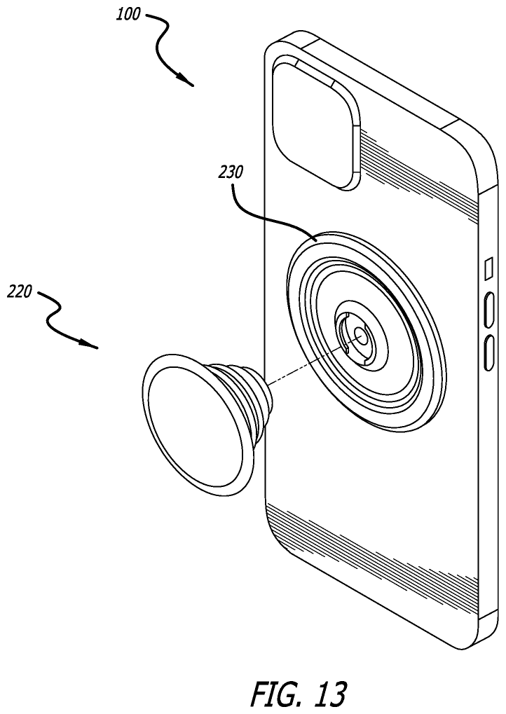

FIGS. 11-13 depict various views of another accessory of the present disclosure, in the case in the form of modular grip accessory 220, which is similar to the grip accessory of FIGS. 9-10, but which further comprises a detachable platform 230. As shown, the modular grip accessory 220 is removably coupled to mobile electronic device 100 by way of the detachable platform 230. Detachable platform 230 is attachable to the rear surface of mobile electronic device 100 by magnetic, adhesive, or mechanical means and is constructed to be detachable. In certain embodiments, detachable platform 230 may be attached to the mobile electronic device 100 based on a magnetic attachment with one or more magnets 101 that are integrated into the mobile electronic device 100, as described above with reference to FIGS. 9-10, the entire description of which is intended to also apply to the embodiment of FIGS. 11-13. For example, detachable platform 230 may comprise metallic and/or magnetic elements (not shown) which are attracted to the plurality of magnets 101 of the mobile electronic device 100 when the detachable platform 230 and device 100 are brought within a sufficiently close proximity to each other. As with the example of FIGS. 9-10 above, the plurality of magnets 101 of FIGS. 11-13 may comprise a single ring-shaped magnet, a single disc-shaped magnet, one or more additional magnets disclosed nearer the base or edge of the phone, or any combination thereof. Similarly, the metallic and/or magnetic elements of the detachable platform 230 may have a ring or disc shape, or comprise individual magnets (or metal) disposed in any pattern along the attachment side of the detachable platform 230.

In addition, the modular grip accessory 220 of FIGS. 11-13 may be configured as an expandable grip accessory 200. It will be understood that alternatives to modular grip accessory 200 are described above with reference to FIGS. 9-10, the entire description of which is intended to also apply to the embodiment of FIGS. 11-13. Alternatively, the accessory 220 may include wired and wireless power banks, mechanical accessories, speakers, and ear buds, among other accessories.

Grip accessory 220 may be detachably connected to platform 230 using magnetic or mechanical means, including for example, the connection system disclosed in U.S. Pat. No. 10,348,352, filed on May 30, 2018 and issued on Jul. 9, 2019, the entire disclose of which is hereby incorporated by reference.

FIGS. 14-19 depict various view of an accessory attachment system configured as a mobile electronic device case 400 with an accessory recess area 401 and separate secondary accessory magnetic attachment area 402. In FIG. 14, a grip-type accessory 410 may be attached to the case 400 in accordance with the above magnetic and/or mechanical attachment teachings, all of which are incorporated here with respect to FIG. 14. In FIG. 14, the image on the left depicts a grip-type accessory in a collapsed state that is essentially flush with the flat rear surface of case 400, while the image on the right depicts the grip-type accessory in an expanded state. However, it should be appreciated that accessory recess area 401 may not provide for an entirely flush surface when the height of the accessory, even in a collapsed state, exceeds the depth of area 401.

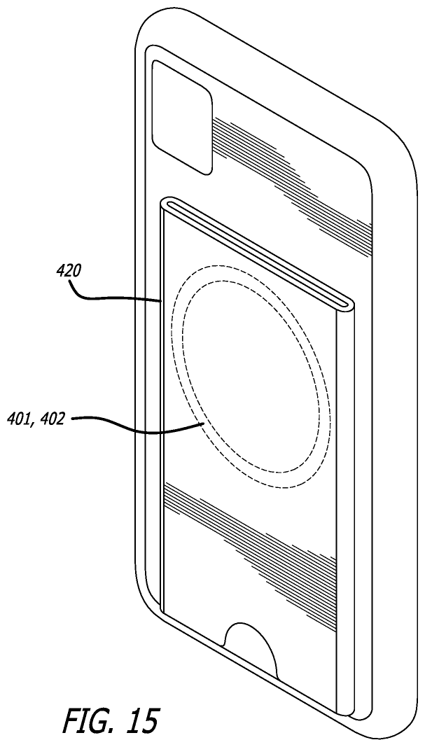

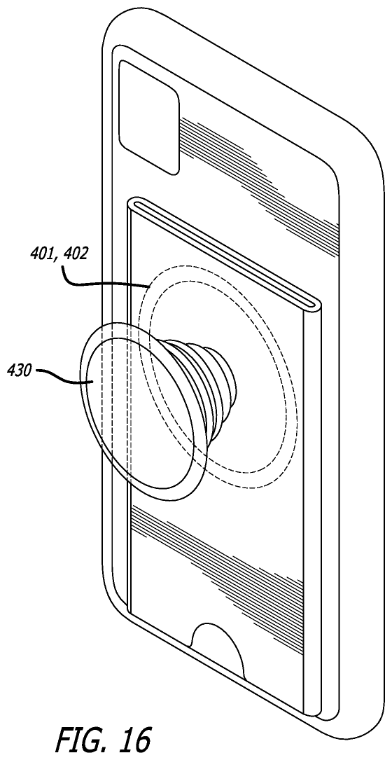

FIG. 15 depicts another embodiment of an accessory attachment system, in this case using a wallet type accessory 420, which can be attached to the device case 400 via the accessory magnetic attachment area 402 in accordance with the above magnetic and/or mechanical attachment teachings, all of which are incorporated here with respect to FIG. 15.

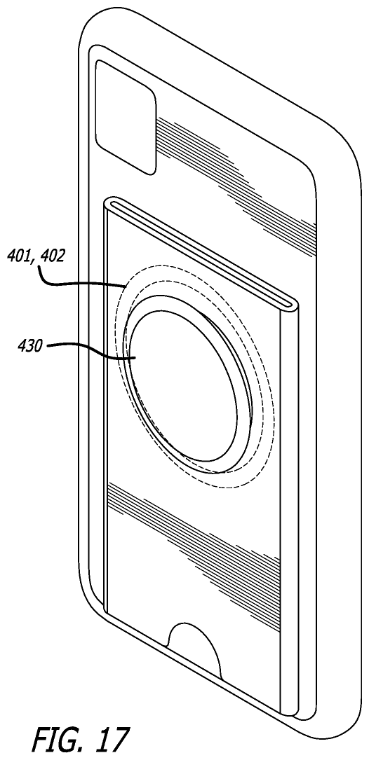

FIG. 16 depicts another embodiment of an accessory attachment system, in this case using a combined grip and wallet type accessory 430, which can be attached to the device case 400 via the accessory magnetic attachment area 402 in accordance with the above magnetic and/or mechanical attachment teachings, all of which are incorporated here with respect to FIG.

16.

FIG. 17 depicts the embodiment of FIG. 16 in which the grip of the combined grip and wallet type accessory is in a collapsed state.

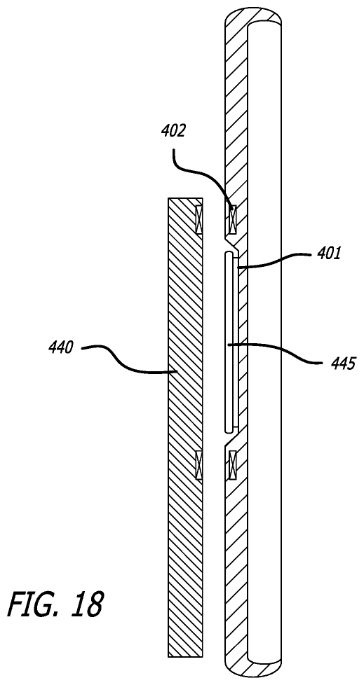

FIG. 18 depicts another embodiment of an accessory attachment system, in this case based on an internal accessory 445 that is recessed within area 401, along with an outer accessory 440, where outer accessory and/or internal accessory 445 can be attached to the device case 400 via the accessory magnetic attachment area 402 in accordance with the above magnetic and/or mechanical attachment teachings, all of which are incorporated here with respect to FIG. 18. Alternatively, one or both of accessories 440, 445 may be attached via mechanical or adhesive means. In some embodiments, internal accessory 445 may be a grip-type accessory and outer accessory 440 may a wallet or power bank type accessory.

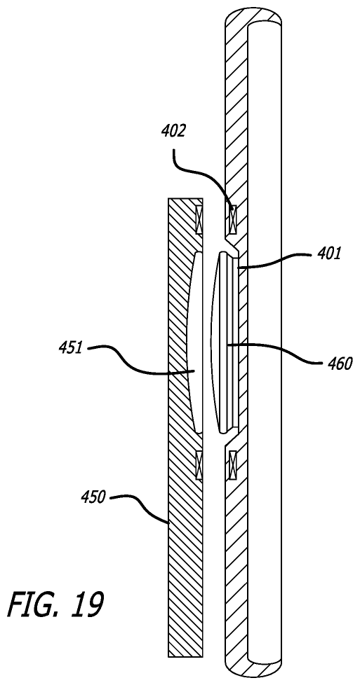

FIG. 19 depicts another embodiment of an accessory attachment system, in this case based on an internal accessory 460 that is recessed within area 401, along with an outer accessory 450, where outer accessory and/or internal accessory 450, 460 can be attached to the device case 400 via the accessory magnetic attachment area 402 in accordance with the above magnetic and/or mechanical attachment teachings, all of which are incorporated here with respect to FIG. 19. Alternatively, one or both of accessories 450, 460 may be attached via mechanical or adhesive means. In some embodiments, internal accessory 460 may be a grip-type accessory and outer accessory 450 may a wallet or power bank type accessory. It should be appreciated that the primary difference between the examples of FIGS. 18 and 19 is that accessory 440 in FIG. 18 is able to mount flush to a rear surface of the case 400 because accessory 445 is completely contained in the recessed area 401, while in FIG. 19 accessory 450 includes a separate recess area 451 that accommodates accessory 460 which is not completely contained in the recessed area 401.

In one or more embodiments, the grip accessory 200 and/or 410 may be configured in accordance with the expandable/collapsible design of the commercially available grip and stand product available from PopSockets™. For example, U.S. Pat. No. 8,560,031, filed on Feb. 23, 2012; U.S. Pat. No. 9,970,589, filed on Nov. 9, 2017; U.S. application Ser. No. 15/615,900, filed on Jun. 7, 2017; U.S. application Ser. No. 15/679,934, filed on Aug. 17, 2017; U.S. application Ser. No. 15/803,410, filed on Nov. 3, 2017; U.S. application Ser. No. 15/808,076, filed on Nov. 9, 2017; U.S. application Ser. No. 15/864,402, filed on Jan. 8, 2018; U.S. application Ser. No. 15/864,509, filed on Jan. 8, 2018; U.S. application Ser. No. 15/906,920, filed on Feb. 27, 2018; U.S. application Ser. No. 15/922,601, filed on Mar. 15, 2018; U.S. application Ser. No. 15/952,025, filed on Apr. 12, 2018; U.S. application Ser. No. 15/993,458, filed on May 30, 2018; and U.S. application Ser. No. 16/001,723, filed on Jun. 6, 2018 each describe suitable grip accessories, the entirety of each being hereby incorporated by reference.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of various embodiments. This description should be read to include one or at least one and the singular also includes the plural unless it is obvious that it is meant otherwise.

It will be appreciated that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. The same reference numbers may be used to describe like or similar parts. Further, while several examples have been disclosed herein, any features from any examples may be combined with or replaced by other features from other examples. Moreover, while several examples have been disclosed herein, changes may be made to the disclosed examples within departing from the scope of the claims.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. An accessory assembly comprising:
a platform, having a first side and an opposing second side, the platform comprising one or more magnetic elements configured to magnetically attach the platform to a mobile electronic device along the first side; and
a grip accessory configured to attached to the second side of the platform, wherein the grip accessory is configured to be handheld to support the mobile electronic device when magnetically attached to the platform.

2. The accessory of claim 1, wherein the one or more magnetic elements comprises one or more individual magnets.

3. The accessory of claim 1, wherein the one or more magnetic elements are configured to attach the platform to a mobile electronic device that comprises at least one integrally-formed magnet.

4. The accessory of claim 1, wherein the one or more magnetic elements have a circular shape.

5. The accessory of claim 4, wherein the one or more magnetic elements are disposed along a periphery of the circular shape.

6. The accessory of claim 5, further comprising an alignment element arranged separate from the one or more magnetic elements.

7. The accessory of claim 6, wherein the platform comprises a substantially oval shape, whereby the one or more magnetic elements are arranged towards one end of the substantially oval shape and the alignment element is arranged towards an opposite end of the substantially oval shape.

8. The accessory of claim 1, wherein the one or more magnetic elements comprises a disc shaped magnetic element.

9. The accessory of claim 1, wherein the grip accessory is configured to be detachably attached to the platform by an attachment mechanism.

10. The accessory of claim 1, wherein the grip accessory comprises one of a ring, accordion, strap, and kickstand structure.
